(19) United States
(12) Patent Application Publication
(10) Pub. No.: US 2001/0007144 A1
(43) Pub. Date: Jul. 5, 2001

(54) Hold violation improvement method, semiconductor integrated circuit, and program for executing hold violation improvement method by computer

(75) Inventor: Toshihiro Terazawa, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/752,446

(22) Filed: Jan. 3, 2001

(30) Foreign Application Priority Data
Jan. 4, 2000 (JP) P2000-99

(51) Int. Cl. G06F 17/50; G06F 9/45

(52) U.S. Cl. 716/6; 716/4

(57) ABSTRACT

In the hold violation improvement method of the present invention, when a hold violation occurs in a path from a first sequential circuit (101) to a second sequential circuit (102) in a semiconductor integrated circuit, a timing analysis is performed for cells in the path from an input side in the path. A delay cell is inserted into the path so that the delay time of the path is over the worst delay time of the cell. The series of the above processes is repeated from the hold worst path having the worst hold violation to other paths having the hold violation, in order, without decreasing any time margin to avoid a setup violation.

### CROSS-REFERENCE TO RELATED APPLICATION

This application claims benefit of priority under 35 USC §119 to Japanese Patent Application No. 2000-99, filed on Jan. 4, 2000, the entire contents of which are incorporated herein by reference herein.

### BACKGROUND OF THE INVENTION

1. Field of the Invention

The present invention relates to a hold violation improvement method of improving a hold violation that occurs in a path in a semiconductor integrated circuit, a semiconductor integrated circuit obtained by applying the hold violation improvement method, and a program for executing the hold violation improvement method by a computer.

2. Description of the Related Art

In a case that a semiconductor integrated circuit having sequential circuits (such as F/Fs), it must be required to satisfy hold constraints for sequential circuits in a timing analysis in order to realize a desired performance.

When a hold violation occurs between a sequential circuit A and a sequential circuit B that forms a path in a semiconductor integrated circuit, where a delay value is so small, a conventional algorithm to improve the hold violation inserts a delay cell at a previous stage of the sequential circuit as the termination of the path of the hold violation. In the conventional algorithm, when there is no time margin that is necessary to avoid an occurrence of a setup violation after the delay cell is inserted at this previous stage, namely, the setup violation occurs, one or more delay cells are inserted at acceptable positions from the terminal of this path in order.

However, this conventional algorithm improves the hold violation by decreasing the time margin toward a limited value as long as the setup violation does not occur. This conventional drawback will be explained by reference to FIG. 1, FIG. 2, and FIG. 3.

FIG. 1 is a circuit diagram showing a conventional semiconductor integrated circuit having sequential circuits and combination circuits.

The semiconductor integrated circuit shown in FIG. 1 has sequential circuits 101, 102, 103 and combination circuits 104 and 105 connected between the sequential circuits 101 and 102. The sequential circuit 103 is also connected to the combination circuit 105.

As shown in FIG. 1, there are paths A and B in the semiconductor integrated circuit. The path A is from the sequential circuit 101 to the sequential circuit 102, and the path B is from the sequential circuit 103 to the sequential circuit 102.

In the following explanation, the delay time of a signal transferred from the sequential circuit 101 to the sequential circuit 102 through the combination circuits 104 and 105 is T1, and the delay time of a signal transferred from the sequential circuit 103 to the sequential circuit 102 through the combination circuit 105 is T2.

In the relationship between the delay times T1 and T2 and the clock CK shown in FIG. 2, the time margin in order to avoid any occurrence of the setup violation in the path A becomes T5 and the path B arises the time T6 of the hold violation under the condition of the setup time T3 of the sequential circuits 101, 102, and 103, and the hold time T4.

In order to improve this time T6 of the hold violation, the conventional algorithm inserts the delay cell 110 between the sequential circuit 102 and the combination circuit 105, as shown in FIG. 1. The insertion of the delay cell 110 increases the delay time in the path B (see DL in FIG. 3) and thereby can eliminate the hold violation.

Next, a description will be given of the explanation to improve the hold violation in another semiconductor integrated circuit by the conventional algorithm with reference to FIG. 4.

This semiconductor integrated circuit has the selector 201 of three inputs and one output. The input pins A and B of the selector 201 are connected to the combination circuits 202 and 203, respectively, and the input pin S thereof is connected to the sequential circuit 204. The output pin Z is connected to the sequential circuit 205.

In the configuration shown in FIG. 4, there is the path M from the combination circuit 202 to the sequential circuit 205 through the input pin A and the output pin Z of the selector 201. There is also the path N from the combination circuit 203 to the sequential circuit 205 through the input pin B and the output pin Z of the selector 201 and there is also the path S from the sequential circuit 204 to the sequential circuit 205 through the input pin S and the output pin Z of the selector 201. We define that the delay time of the path M is T11, the delay time of the path N is T12, and the delay time of the path S is T13. In the relationship among the delay times T11, T12, and T13 and the clock CK shown in FIG. 5, the time margin to avoid an occurrence of the setup violation in the path M becomes T5, the time margin to avoid an occurrence of the setup violation in the path N becomes T7, and path S has the time T6 of the hold violation in the hold time.

In order to improve the time T6 of the hold violation in the hold time, the conventional algorithm inserts the delay cell 220 between the selector 201 and the sequential circuit 205, as shown in FIG. 4. This insertion of the delay cell 220 increases the delay in the path S (see DL in FIG. 6) and thereby eliminates the hold violation.

However, the conventional algorithm described above has the following drawbacks (1) and (2).

(1) In the semiconductor integrated circuit shown in FIG. 1, the insertion of the delay cell 110 increases the delay in the path B (see T2′ in FIG. 3), so that the hold violation can be eliminated. However, the insertion of the delay cell 110 also increases the delay in the path A (see T1′ in FIG. 3). This decreases the time margin T5 to avoid an occurrence of the setup violation (see DL in FIG. 3). Because this time margin T5 is required during the layout process of the semiconductor integrated circuit, the time margin T5 for avoiding the occurrence of the setup violation must be adequately remained as much as possible.

(2) In the semiconductor integrated circuit shown in in FIG. 4, the insertion of the delay cell 220 increases the delay time in the path S (see T13′ in FIG. 6), so that the hold violation can be eliminated. However, the insertion of the delay cell 220 also increases the delay in each of the paths M and N (see T11′ and T12′ in FIG. 6). This decreases the time margins T5 and T7 to avoid an occurrence of the setup violation. Similar to the above case (1), because these time margins T5 and T7 are required during the layout process of the semiconductor integrated circuit, the time margins T5 and T7 for avoiding the occurrence of the setup violation must be adequately remained as much as possible.

### SUMMARY OF THE INVENTION

Accordingly, an object of the present invention is, with due consideration to the drawbacks of the conventional technique, to provide a hold violation improvement method of improving a hold violation in a path in a semiconductor integrated circuit without decreasing a time margin to avoid any occurrence of a setup violation, to provide a semiconductor integrated circuit obtained by applying the hold violation improvement method, and to provide a program for executing the hold violation improvement method by a computer.

In accordance with a preferred embodiment of the present invention, the hold violation improvement method comprises the steps of: performing a timing analysis for cells in a path sequentially from a first sequential circuit to a second sequential circuit when a delay time from the first sequential circuit to the second sequential circuit is low and a hold violation thereby occurs in the path; and inserting a delay cell having a delay time so that the delay time of the delay cell is not over a maximum delay value to an input pin of the cell.

In addition, in accordance with another preferred embodiment of the present invention, a hold violation improvement method, comprises the steps of: performing a path analysis for a semiconductor integrated circuit, and selecting a hold worst path in all paths in the semiconductor integrated circuit; judging whether or not the hold worst path has a hold violation; setting a cell as a target cell for the analysis from a start point of the hold worst path in order, when the hold worst path has the hold violation; and obtaining a maximum delay time of the target cell by performing the path analysis for all inputs of the target cell, and inserting one or more delay cells for improving the hold violation into the hold worst path so that a total delay time of the target cell is not over the maximum delay time of the target cell.

In addition, in the hold violation improvement method described above, the insertion process of the delay cells is repeated until the hold violation of the hold worst path is eliminated.

Furthermore, in the hold violation improvement method described above, after the hold violation of the hold worst path has been eliminated, the series of the processes for the hold violation improvement of the hold worst path is repeated for all paths having the hold violation in the semiconductor integrated circuit other than the hold worst path.

Moreover, in the hold violation improvement method described above, after the hold violation of the hold worst path has been eliminated, the series of the processes for the hold violation improvement of the hold worst path is repeated for all paths having the hold violation in the semiconductor integrated circuit other than the hold worst path.

In accordance with another preferred embodiment of the present invention, a semiconductor integrated circuit is obtained by applying the hold violation improvement method of the present invention.

In accordance with another preferred embodiment of the present invention, a program for executing the hold violation improvement method by a computer, comprises the procedures of: performing a timing analysis for cells in a path sequentially from a first sequential circuit to a second sequential circuit when a delay time from the first sequential circuit to the second sequential circuit is low and a hold violation thereby occurs in the path; and inserting a delay cell having a delay time so that the delay time of the delay cell is not over a maximum delay value to an input pin of the cell.

In accordance with another preferred embodiment of the present invention, a program for executing the hold violation improvement method by a computer comprises the procedures of: performing a path analysis for a semiconductor integrated circuit, and selecting a hold worst path in all paths in the semiconductor integrated circuit; judging whether or not the hold worst path has a hold violation; setting a cell as a target cell for the analysis from a start point of the hold worst path in order, when the hold worst path has the hold violation; and obtaining a maximum delay time of the target cell by performing the path analysis for all inputs of the target cell, and inserting one or more delay cells for improving the hold violation into the hold worst path so that a total delay time of the target cell is not over the maximum delay time of the target cell.

Furthermore, in the program for executing the hold violation improvement method by a computer described above, the insertion process of the delay cells is repeated until the hold violation of the hold worst path is eliminated.

Moreover, in the program for executing the hold violation improvement method by a computer described above, after the hold violation of the hold worst path has been eliminated, the series of the processes for the hold violation improvement of the hold worst path is repeated for all paths having the hold violation in the semiconductor integrated circuit other than the hold worst path.

### BRIEF DESCRIPTION OF THE DRAWINGS

These and other objects, features, aspects and advantages of the present invention will become more apparent from the following detailed description of the present invention when taken in conjunction with the accompanying drawings, in which:

FIG. 1 is a circuit diagram showing a configuration of a conventional semiconductor integrated circuit having sequential circuits and combination circuits;

FIG. 2 is a timing chart showing an operation of the semiconductor integrated circuit shown in FIG. 1;

FIG. 3 is a timing chart showing an application result of a conventional algorithm for improving a hold violation;

FIG. 4 is a circuit diagram showing a configuration of another conventional semiconductor integrated circuit having sequential circuits and combination circuits;

FIG. 5 is a timing chart showing an operation of the semiconductor integrated circuit shown in FIG. 4;

FIG. 6 is a timing chart showing an application result of the conventional algorithm for improving a hold violation;

FIG. 7 is a flow chart showing the operation of a hold violation improvement method according to a preferred embodiment of the present invention;

FIG. 8 is a circuit diagram showing a semiconductor integrated circuit as a first application example to which the hold violation improvement method of the preferred embodiment of the present invention is applied;

FIG. 9 is a timing chart showing an application result of the algorithm in the hold violation improvement method of the preferred embodiment of the present invention;

FIG. 10 is a circuit diagram showing a semiconductor integrated circuit as a second application example to which the hold violation improvement method of the preferred embodiment of the present invention is applied;

FIG. 11 is a timing chart showing an application result of the algorithm in the hold violation improvement method of the preferred embodiment of the present invention; and

FIG. 12 is a circuit diagram showing a semiconductor integrated circuit as a third application example to which the hold violation improvement method of the preferred embodiment of the present invention is applied.

### DESCRIPTION OF THE PREFERRED EMBODIMENTS

Other features of this invention will become apparent through the following description of preferred embodiments which are given for illustration of the invention and are not intended to be limiting thereof.

First embodiment

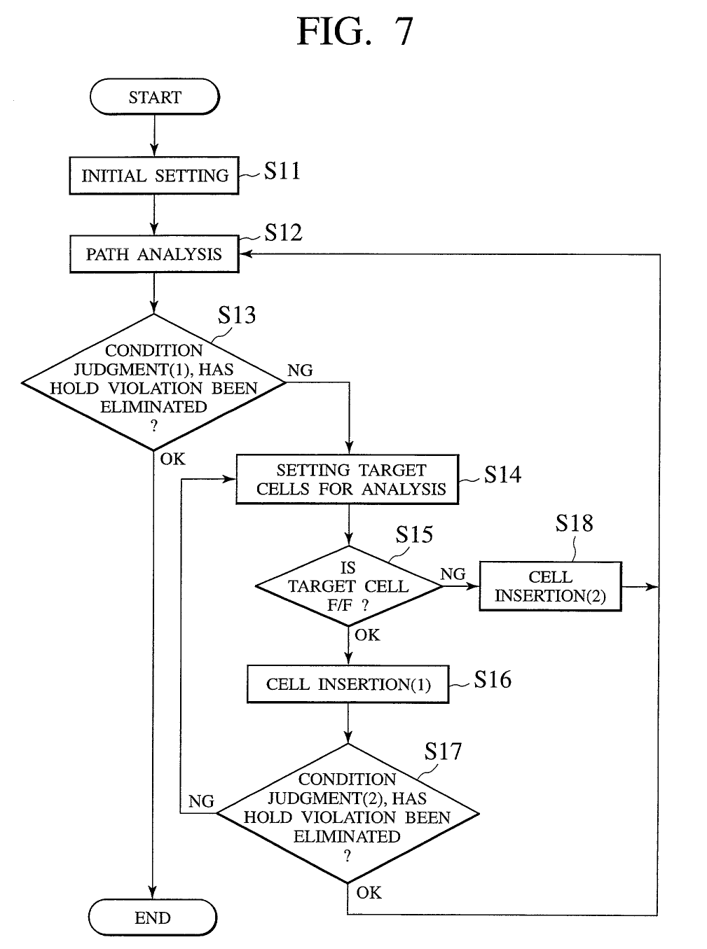

FIG. 7 is a flow chart showing the operation of the hold violation improvement method according to a preferred embodiment of the present invention.

A description will be given of the algorithm of the hold violation improvement method of the present invention.

First, at Step S11, a kind and a priority of each delay cell to be inserted during the execution of the hold violation improvement method is determined as an initial setting.

At following Step S12, a path analysis is performed for target paths in a semiconductor integrated circuit, and the path having the worst hold violation is determined. This path is called to as the hold worst path.

At Step S13, when there is no hold violation in any path as the result of the path analysis executed at Step S12 (when OK, see Step S13 in FIG. 7), the operation flow goes to the END. In this case, the algorithm is completed. When there is the hold violation occurred in at least a path, the operation flow goes to Step S14 where the setting process for setting a target cell in the selected path is performed.

At Step S14, the target cell in the path to be analyzed is the first cell counted from the start point of the hold worst path when the operation flow is shifted from Step S13 where the condition judgment (1) is performed. On the other hand, when the operation flow is shifted from Step S17 where the condition judgment (2) is performed, the target cell becomes the cell that follows the target cell that has been selected at Step S14 in the previous processing.

Next, the operation flow goes to Step S15 at which it is determined whether or not the target cell to be analyzed is a sequential circuit (such as F/F). When it is not the sequential circuit, the cell insertion process (1) is performed at Step S16. In this cell insertion process (1), the path analysis is performed for all pins of the cell that has been set in the cell setting process for the analysis at Step S14. As the result of the path analysis, the maximum delay in the delay times from each input pin to the output pin in the target cell for the analysis is set as the maximum delay value. A delay cell to be used for improving the hold violation is then inserted at a previous stage of the input pin in the hold worst path. Although this insertion increases the delay time to the output pin in the hold worst violation, the insertion process is continued until the hold violation is improved within the range of the maximum delay value.

The condition in order to shift the operation flow from the cell insertion process to the following process is one of the following two cases: The hold violation in the hold worst path can be improved; and The delay time becomes over the maximum delay value when any additional delay cell is inserted.

In one of the above two cases, the cell insertion process is completed and the operation flow goes to Step S17 where the condition judgment (2) will be performed. However, when the cell that has been set at Step S15 is the terminal cell in the hold worst path, the additional delay cell is inserted until the hold violation can be eliminated.

In the process of the condition judgment (2) performed at Step S17, the timing analysis is performed for the hold worst path. When the hold violation is eliminated (when OK), the operation flow goes to Step S12 where the path analysis is performed. When the hold violation has not been eliminated (when NG), the operation flow is returned to Step S14 where the cell setting process for the analysis is performed (This operation has been described above).

When the hold violation in the hold worst path has been eliminated, the process flow goes to Step S12. In Step S12, the path analysis is performed for the path having the hold violation of a next degree of the worst hold violation. Then the delay cells are inserted into this path. These processes are the same as the processes for the hold worst path described above. These processes are repeated for all the paths having the hold violation in series.

By the way, when the judgment of the process at Step S15 judges that the target cell is the sequential circuit (such as F/F), the operation flow goes to Step S18 where the cell insertion (2) is performed. In this process of the cell insertion (2), delay cells are inserted into the target path until the hold violation therein is completely eliminated. After this process of Step S18, the operation flow goes to Step S12.

Next, a description will be given of the first, second, and third examples in which the algorithm of the hold violation improvement method of the present invention is applied to semiconductor integrated circuits having various configurations.

First application example

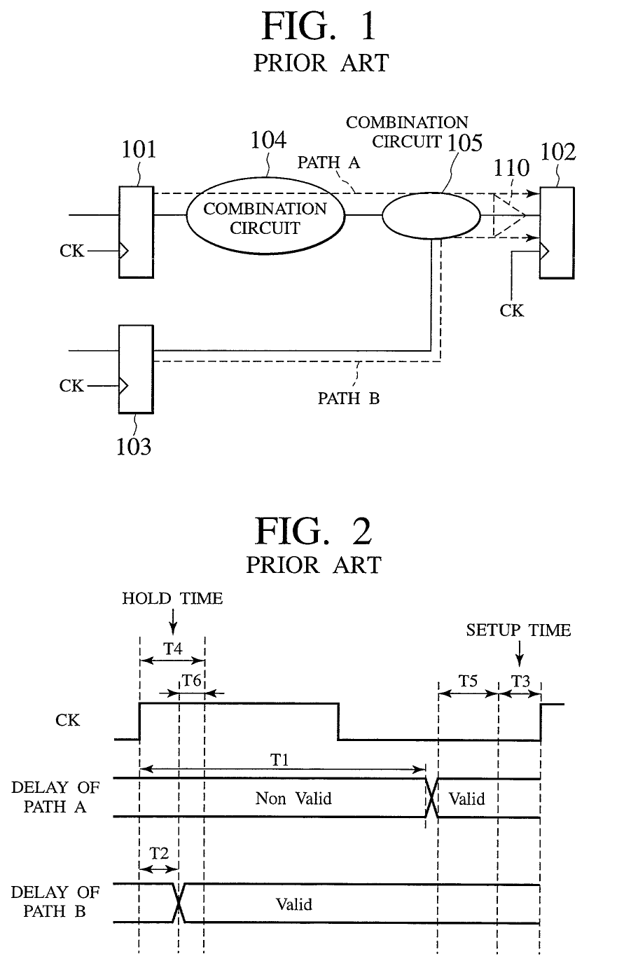

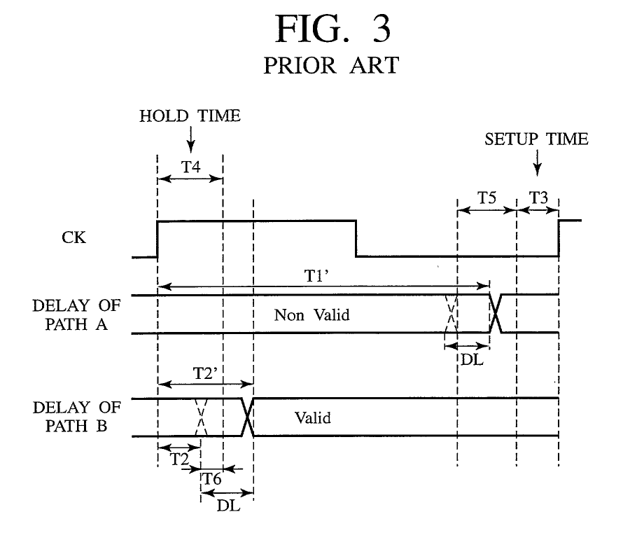

The algorithm of the hold violation improvement method of the preferred embodiment of the present invention is applied to the semiconductor integrated circuit shown in FIG. 1.

The conditions in FIG. 2 are determined as follows: The period of the clock CK is 10 [ns]; the delay time T1 to the sequential circuit 102 in the path A is 8 [ns]; and the delay time T2 to the sequential circuit 102 in the path B is 3 [ns]. In addition, the setup time T3 and the hold time T4 of the sequential circuit 102 are 0.5 [ns] and 0.5 [ns], respectively.

After the analysis, the time margin of the setup in the sequential circuit 102 becomes 1.5 [ns] because 10.0−8.0−0.5=1.5. However, the hold violation becomes −0.2 [ns] because 0.3−0.5=−0.2.

This hold violation of 0.2 [ns] will be improved and eliminated based on the algorithm of the preferred embodiment shown in FIG. 7.

First, delay cells are selected as the initial setting process (Step S11). Next, the path analysis is performed (Step S12). As the result, we assume that the sequential circuit 103 is the start point in the following processes and the path B including the combination circuit 105 is the hold worst path. That is, the sequential circuit 102 arises the hold violation.

The operation flow goes from the process of the condition judgment (1) at Step S13 to the cell setting process for the analysis at Step S14 because the path analysis at Step S12 indicates that the path B includes the hold violation.

In the hold violation improvement method of the preferred embodiment according to the present invention, the combination circuit 105 following to the sequential circuit 103 is selected as the target cell for the analysis because the start point in the hold worst path (namely, the path B) is the sequential circuit 103.

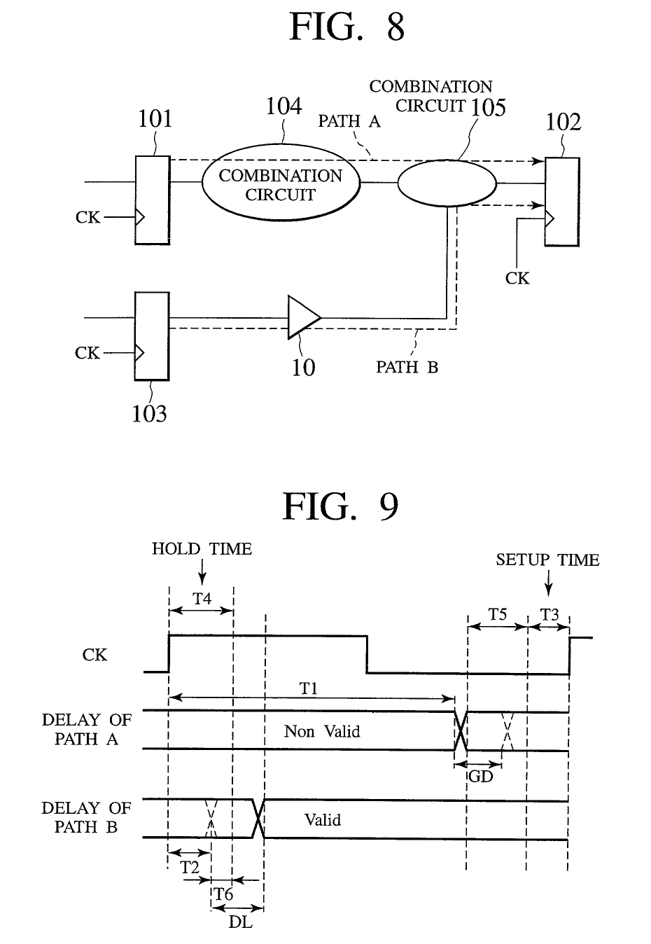

In the cell insertion process, the input pins of the combination circuit 105 will be analyzed. Because the delay values in the path A and the path B are 8 [ns] and 0.3 [ns], respectively, as the analysis results, the maximum delay value becomes 8 [ns]. The delay cell 10 is inserted at the previous stage (between the sequential circuit 103 and the combination circuit 105) of the input pin of the combination circuit 105 in the path B without over the range of the maximum delay time (see FIG. 8). FIG. 8 is the circuit diagram showing the semiconductor integrated circuit as the first application example to which the hold violation improvement method of the preferred embodiment of the present invention is applied. The insertion of the delay cell 10 eliminates the hold violation in the path B.

In the process of the condition judgment (2) at Step S17, the operation flow goes to Step S12 for the path analysis process because the hold violation has been eliminated. The operation flow goes to END (when OK) when the semiconductor integrated circuit has no path having the hold violation. The program for executing the hold violation improvement method is thereby stopped.

FIG. 9 is the timing chart showing the application result of the algorithm in the hold violation improvement method of the preferred embodiment of the present invention. As clearly shown in FIG. 9, the insertion of the delay cell 10 increases the delay time (see DL in FIG. 9) in the path B. This can eliminate the hold violation of path B.

In addition, because the insertion of the delay cell 10 does not increase the delay time in the path A (see T1 in FIG. 9), the time margin T5 for avoiding an occurrence of the setup violation does not increase (see GD in FIG. 9).

Second application example

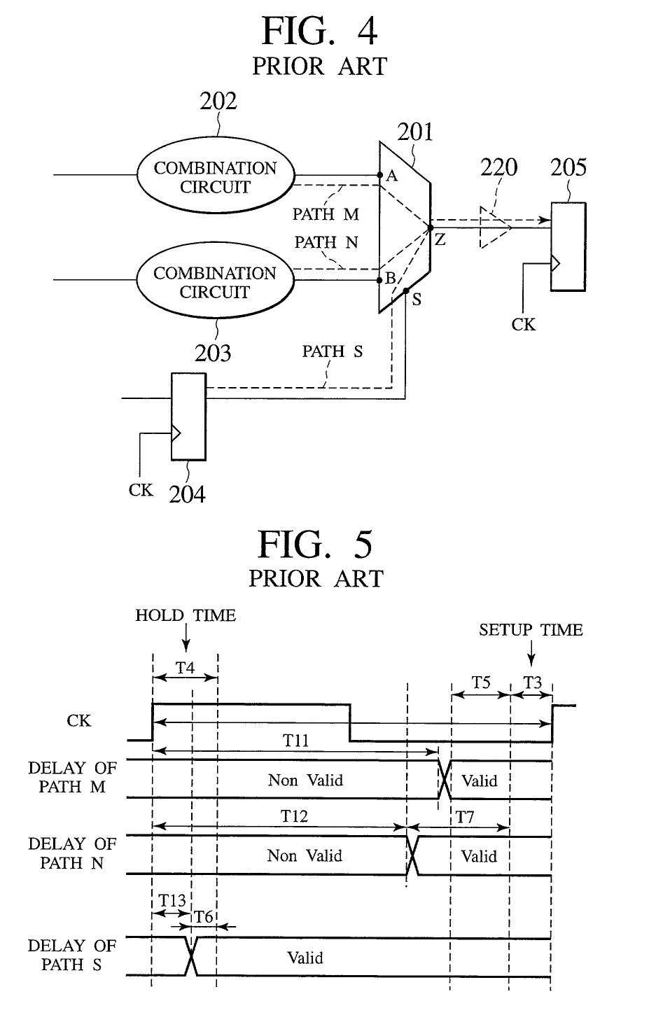

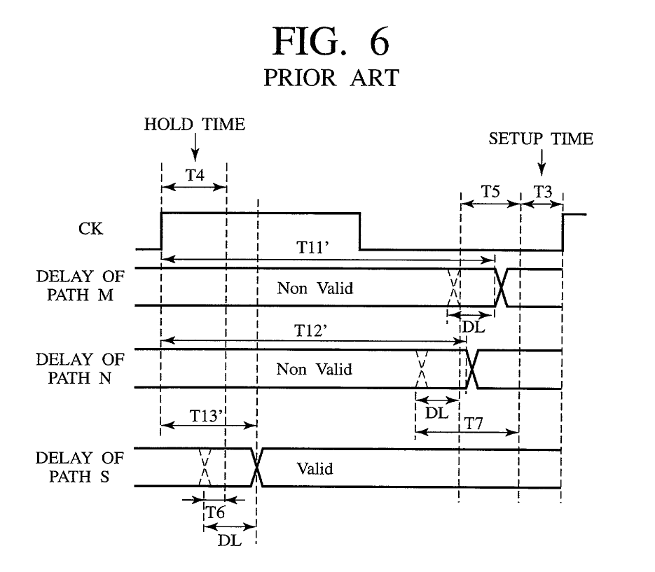

The algorithm of the hold violation improvement method of the preferred embodiment of the present invention is applied to the semiconductor integrated circuit shown in FIG. 4.

In FIG. 5, the following conditions are determined. The period of the clock CK is 10 [ns], the delay time T11 to the sequential circuit 205 in the path M is 8 [ns], the delay time T12 to the sequential circuit 205 in the path N is 7 [ns], and the delay time T13 to the sequential circuit 205 in the path S is 0.3 [ns]. In addition, the setup time T3 and the hold time T4 of the sequential circuit 205 are 0.5 [ns] and 0.5 [ns], respectively.

As the result of the analysis based on these conditions, the time margin of the setup in the sequential circuit 205 becomes 1.5 [ns] because 10.0−8.0−0.5=1.5. However, the hold violation becomes −0.2 [ns] because 0.3−0.5=−0.2. This hold violation of 0.2 [ns] will be improved and eliminated based on the algorithm of the preferred embodiment shown in FIG. 7.

First, delay cells are selected as the initial setting process (Step S11). Next, the path analysis is performed (Step S12). As the result, we assume that the sequential circuit 204 is the start point in the following processes and the path S through the S pin and the Z pin of the selector 201 is the hold worst path. That is, the sequential circuit 206 arises the hold violation.

The operation flow goes from the process of the condition judgment (1) at Step S13 to the cell setting process for the analysis at Step S14 because the path analysis at Step S12 indicates that the path S includes the hold violation.

In the hold violation improvement method of the preferred embodiment according to the present invention, the selector 201 following to the sequential circuit 204 is selected as the target cell for the analysis because the start point in the hold worst path (namely, the path S) is the sequential circuit 204.

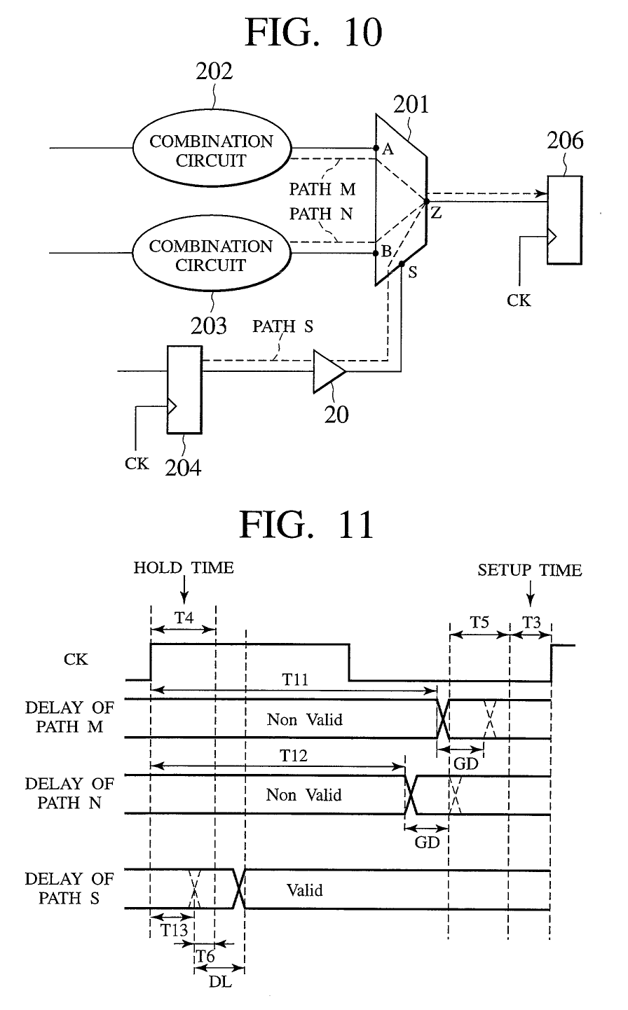

In the cell insertion process, the input pins A, B, and S of the combination circuit 201 will be analyzed. Because the delay values in the path M,N, and S are 8 [ns], 7 [ns],and 0.3 [ns], respectively, as the analysis results, the maximum delay value becomes 8 [ns]. The delay cell 20 is inserted at the previous stage of the S pin of the selector 201 in the path S without over the range of the maximum delay time (see FIG. 10). FIG. 10 is the circuit diagram showing the semiconductor integrated circuit as the second application example to which the hold violation improvement method of the preferred embodiment of the present invention has been applied. The insertion of the delay cell 20 eliminates the hold violation in the path S.

In the process of the condition judgment (2) at Step S17, the operation flow goes to Step S12 for the path analysis process because the hold violation has been eliminated. The operation flow goes to END (when OK) when the semiconductor integrated circuit has no path having the hold violation. The program for executing the hold violation improvement method is thereby stopped.

FIG. 11 is the timing chart showing the application result of the algorithm in the hold violation improvement method of the preferred embodiment of the present invention. FIG. 11 shows the result of the hold violation improvement method. As clearly shown in FIG. 11, the insertion of the delay cell 20 increases the delay time (see DL in FIG. 11) in the path S. This can eliminate the hold violation of the path S. In addition, because the insertion of the delay cell 20 does not increase the delay time in each of the path M and the path N (see T11 and T12 in FIG. 11), the time margins T5 and T7 for avoiding an occurrence of the setup violation does not increase (see GD in FIG. 11).

Third application example

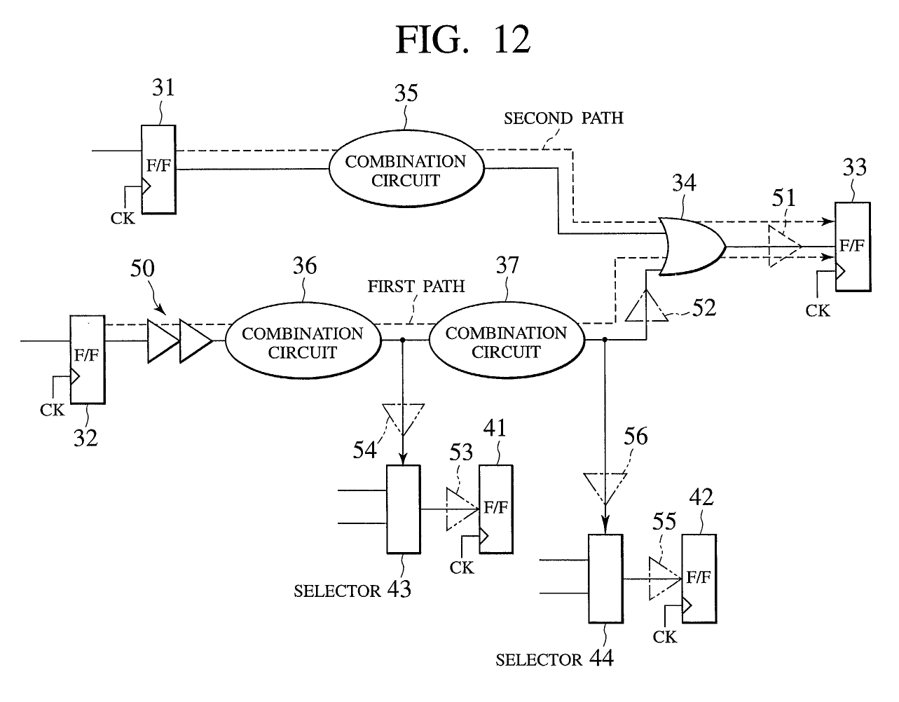

FIG. 12 is the circuit diagram showing the semiconductor integrated circuit as the third application example to which the hold violation improvement method of the preferred embodiment of the present invention is applied. In the semiconductor integrated circuit, an OR gate of two inputs is placed between sequential circuits 31 and 33, and between a sequential circuit 32 and the sequential circuit 33. In addition, a combination circuit 35 is connected between one input of the OR gate 34 and the sequential circuit 31, combination circuits 36 and 37 are connected between another input of the OR gate 34 and the sequential circuit 32, a selector 43 and a sequential circuit 41 are connected to the connection node between the combination circuits 36 and 37, and a selector 44 and a sequential circuit 42 are connected to the connection node between the combination circuit 37 and the OR gate 34.

In FIG. 12, we assume that a first path is from the sequential circuit 32 to the sequential circuit 33 through the combination circuits 36 and 37, and the OR gate 34.

In the conventional algorithm (that has been described in the prior art section in this specification), the delay cell 51 is inserted by considering the timing of the second path from a sequential circuit 31 to the sequential circuit 33 through the combination circuit 35 and the OR gate 34. If the hold violation can not been eliminated, the conventional method inserts the additional delay cell 52 at the input side of the OR gate 34 in the first path. Further, if the path to the sequential circuit 41 has the hold violation, the additional delay cell 53 is inserted between the selector 43 and the sequential circuit 41. If the hold violation cannot still be eliminated, the additional delay cell 54 is inserted between the combination circuit 36 and the selector 43. Similarly, if the path to the sequential circuit 42 has the hold violation, the additional delay cell 55 is inserted between the selector 44 and the sequential circuit 42. If the hold violation cannot still be eliminated, the additional delay cell 55 is also inserted between the combination circuit 37 and the selector 44.

On the contrary, the hold violation improvement method of the preferred embodiment of the present invention inserts the delay cell 50 only between the sequential circuit 32 and the combination circuit 36, as shown in FIG. 12.

Because the hold violation improvement method of the present invention inserts only the delay cell 50 instead of the plurality of the delay cells 51, 52, 53, 54, 55, and 56, it is possible to reduce the circuit area of the semiconductor integrated circuit and also reduce the power consumption. In addition, because the hold violation improvement method of the present invention does not insert any delay cell into the second path, it is possible to keep the timing margin.

As described above, according to the present invention, it is possible to eliminate and improve the hold violation without decreasing of the time margin to avoid an occurrence of the setup violation. Thereby, it is possible to perform the layout process of a semiconductor integrated circuit with a reduced constraint about the cell placement and the wiring, and to increase the quality of the layout design and to reduce the number of processes of the layout, and to reduce the design time. Because the hold violation improvement method of the present invention can improve the fundamental cause arising the hold violation, the number of the delay cells to be added can be reduced, so that it is possible to reduce the area of the semiconductor integrated circuit and the power consumption thereof.

While the above provides a full and complete disclosure of the preferred embodiments of the present invention, various modifications, alternate constructions and equivalents may be employed without departing from the scope of the invention. Therefore the above description and illustration should not be construed as limiting the scope of the invention, which is defined by the appended claims.

What is claimed is:

1. A hold violation improvement method, comprising the steps of:
performing a timing analysis for cells in a path sequentially from a first sequential circuit to a second sequential circuit when a delay time from the first sequential circuit to the second sequential circuit is low and a hold violation thereby occurs in the path; and
inserting a delay cell having a delay time so that the delay time of the delay cell is not over a maximum delay value to an input pin of the cell.

2. A hold violation improvement method, comprising the steps of:
performing a path analysis for a semiconductor integrated circuit, and selecting a hold worst path in all paths in the semiconductor integrated circuit;
judging whether or not the hold worst path has a hold violation;
setting a cell as a target cell for the analysis from a start point of the hold worst path in order, when the hold worst path has the hold violation; and
obtaining a maximum delay time of the target cell by performing the path analysis for all inputs of the target cell, and inserting one or more delay cells for improving the hold violation into the hold worst path so that a total delay time of the target cell is not over the maximum delay time of the target cell.

3. A hold violation improvement method according to claim 2, wherein the insertion process of the delay cells is repeated until the hold violation of the hold worst path is eliminated.

4. A hold violation improvement method according to claim 2, wherein after the hold violation of the hold worst path has been eliminated, the series of the processes for the hold violation improvement of the hold worst path is repeated for all paths having the hold violation in the semiconductor integrated circuit other than the hold worst path.

5. A hold violation improvement method according to claim 3, wherein after the hold violation of the hold worst path has been eliminated, the series of the processes for the hold violation improvement of the hold worst path is repeated for all paths having the hold violation in the semiconductor integrated circuit other than the hold worst path.

6. A semiconductor integrated circuit obtained by applying the hold violation Improvement method as claimed in claim 1.

7. A semiconductor integrated circuit obtained by applying the hold violation improvement method as claimed in claim 2.

8. A semiconductor integrated circuit obtained by applying the hold violation improvement method as claimed in claim 3.

9. A semiconductor integrated circuit obtained by applying the hold violation improvement method as claimed In claim 4.

10. A semiconductor integrated circuit obtained by applying the hold violation improvement method as claimed in claim 5.

11. A program for executing a hold violation improvement method by a computer, comprising the procedures of:
performing a timing analysis for cells in a path sequentially from a first sequential circuit to a second sequential circuit when a delay time from the first sequential circuit to the second sequential circuit is low and a hold violation thereby occurs in the path; and
inserting a delay cell having a delay time so that the delay time of the delay cell is not over a maximum delay value to an input pin of the cell.

12. A program for executing a hold violation improvement method by a computer, comprising the procedures of:
performing a path analysis for a semiconductor integrated circuit, and selecting a hold worst path in all paths in the semiconductor integrated circuit;
judging whether or not the hold worst path has a hold violation;
setting a cell as a target cell for the analysis from a start point of the hold worst path in order, when the hold worst path has the hold violation; and
obtaining a maximum delay time of the target cell by performing the path analysis for all inputs of the target cell, and inserting one or more delay cells for improving the hold violation into the hold worst path so that a total delay time of the target cell is not over the maximum delay time of the target cell.

13. A program for executing a hold violation improvement method by a computer, according to claim 12, wherein
the insertion process of the delay cells is repeated until the hold violation of the hold worst path is eliminated.

14. A program for executing a hold violation improvement method by a computer, according to claim 12, wherein
after the hold violation of the hold worst path has been eliminated, the series of the processes for the hold violation improvement of the hold worst path is repeated for all paths having the hold violation in the semiconductor integrated circuit other than the hold worst path.

15. A program for executing a hold violation improvement method by a computer, according to claim 13, wherein
after the hold violation of the hold worst path has been eliminated, the series of the processes for the hold violation improvement of the hold worst path is repeated for all paths having the hold violation in the semiconductor integrated circuit other than the hold worst path.
